(19) United States
(12) Patent Application Publication
(10) Pub. No.: US 2014/0150685 A1
(43) Pub. Date: Jun. 5, 2014

(54) PISTON-MEDIATED MOTION DAMPENING SYSTEM

(71) Applicant: Stanley J. Checketts, Providence, UT (US)

(72) Inventor: Stanley J. Checketts, Providence, UT (US)

(21) Appl. No.: 14/094,469

(22) Filed: Dec. 2, 2013

Related U.S. Application Data
(60) Provisional application No. 61/731,937, filed on Nov. 30, 2012.

(51) Int. Cl. B61H 9/02; F16F 9/02; F16F 9/19

(52) U.S. Cl. CPC B61H 9/02; F16F 9/19; F16F 9/02
USPC 104/113; 188/301

(57) ABSTRACT

Described herein is a motion dampening system for dampening the motion of a moving object. The system includes a tension member with a first portion and a second portion, where the first portion is positionable to contact the moving object. The system also includes a tubular element that is configured to receive the second portion of the tension member. The tubular element contains a compressible substance. The system further includes a piston that is movable within the tubular element. The piston is coupled to the second portion of the tension member and sealingly divides the tubular element into first and second sections. Contact between the moving object and the first portion of the tension member moves the piston within the cylinder to compress the compressible substance in the first section and to create a vacuum in the second section.

### CROSS-REFERENCE TO RELATED APPLICATION

This application claims the benefit of U.S. Provisional Patent Application No. 61/731,937, filed Nov. 30, 2012, which is incorporated herein by reference.

### FIELD

The present disclosure relates generally to motion dampening systems for regulating the speed of moving objects. In particular, motion-dampening systems that include piston-mediated pneumatic or hydraulic dampening mechanisms are described.

### BACKGROUND

Existing motion dampening systems are used in various contexts and applications. Typically, motion dampening systems regulate the acceleration, deceleration, or peak velocity of a moving object. In a particular context, a motion dampening system might be used to regulate the coupling of rail cars. In another example, a motion dampening system adjusts the landing gear on commercial aircraft. Where a moving body is required to decelerate, accelerate, or travel at velocities falling within particular parameters, a motion dampening system may mediate those velocities. In a context more closely related to the presently described embodiments, motion dampening systems are used to regulate the deceleration and braking of moving amusement ride carriages.

Several factors for utilizing a motion dampening system might be considered in the context of amusement rides with movable passenger carriages. For example, the safety and comfort of carriage passengers, protection and longevity of equipment life, and accuracy and efficiency of the system, may drive the need for motion dampening systems having characteristics suitable for amusement ride applications. However, some known dampening systems are not entirely satisfactory for the range of applications in which they are employed. For example, existing dampening systems often fail to adequately decelerate various passenger carriage types.

Often, a passenger carriage has limited deceleration space and precise passenger off-loading positions. These limits are further enhanced by the inherent requirement to decelerate at a safe and comfortable rate for the passenger(s) riding a carriage. Unacceptable G-forces falling outside of a comfortable range are exerted on passengers when dampening methods are insufficient. Present motion dampening systems often fail to adequately address this combination of needs and continue to operate ineffectively.

Further, existing systems can be unnecessarily complex. The complexity of current dampening systems typically leads to additional manufacturing and resale costs, maintenance needs, equipment down-time, and installation requirements. On the other hand, some non-complex motion dampening systems (e.g., zip line braking systems) fail to hold up over time and are not adaptable to changing carriage-type and load configurations. For instance, conventional spring dampening systems do not maintain a constant spring rate over time due to fatigue, and as a result such systems may begin to experience inadequate deceleration with age. Systems employing a spring-dampened, elastomer-dampened, or other fixed-position dampening device often lose their dampening qualities during repeated use and must be frequently replaced or maintained.

### SUMMARY

The subject matter of the present application has been developed in response to the present state of the art, and in particular, in response to the problems and needs in the art that have not yet been fully solved by currently available motion dampening systems. Accordingly, the subject matter of the present application has been developed to provide apparatus, methods, and systems for dampening motion that overcomes at least some shortcomings of the prior art motion dampening systems, particularly those associated with amusement rides. The few shortcomings described above highlight a gap in existing dampening methods and systems. For example, especially where the size, weight, and cargo associated with a passenger carriage are not always constant, a dampening system should be capable of operating over a range of configurations and given parameters. Thus, there exists a need for motion dampening systems that improve upon and advance the design of known systems. Examples of new and useful motion dampening systems relevant to the needs existing in the field are discussed below.

According to one embodiment, a motion dampening system for dampening the motion of a moving object includes a tension member. The tension member has a first portion and a second portion, where the first portion is positionable to contact the moving object. The system also includes a tubular element that is configured to receive the second portion of the tension member. The tubular element contains a compressible substance. The system further includes a piston that is movable within the tubular element. The piston is coupled to the portion of the tension member and sealingly divides the tubular element into first and second sections. Contact between the moving object and the first portion of the tension member moves the piston within the tubular element (e.g., cylinder) to compress the compressible substance in the first section and to create a vacuum in the second section.

In some implementations, the system also includes a flow regulation device that is operable to control the flow of the compressible substance from the first section. The flow regulation device can be operable to allow a portion of the compressible substance to flow from the first section as the piston moves within the cylinder to compress the compressible substance in the first section.

In yet certain implementations, the system includes a flow regulation device that is operable to control the flow of the compressible substance into the second section. The flow regulation device can be operable to allow a compressible substance to flow into the second section as the piston moves within the cylinder to compress the compressible substance in the first section.

According to some implementations, the system additionally includes a first flow regulation device that is operable to control the flow of the compressible substance from the first section and a second flow regulation device that is operable to control the flow of the compressible substance into the second section. The first and second flow regulation devices are cooperatively operable to allow a portion of the compressible substance to flow from the first section and allow a compressible substance to flow into the second section as the piston moves within the cylinder to compress the compressible substance in the first section.

In certain implementations of the system, the tubular element is elongate in a first direction. The first portion of the tension member can extend perpendicularly relative to the first direction, and the second portion of the tension member extends parallel to the first direction.

In yet some implementations, the system also includes a pulley that is coupled to the tubular element. The pulley is engaged with the first portion of the tension member, and the pulley is swivelable relative to the tubular element to allow the first portion of the tension member to pivot about the pulley.

According to some implementations of the system, the piston includes a first disk, a second disk, and a spacer extending between the first and second disks. The first and second disks move along and form a seal against an interior surface of the tubular element. The piston may include a flow regulation device that is operable to control the flow from the first section to the second section as the piston moves within the cylinder to compress the compressible substance in the first section.

In certain implementations of the system, the moving object is a carriage of an amusement ride that slides along a zip line that extends perpendicularly relative to the first portion of the tension member. The system can further include a stop bracket that is coupled to the first portion of the tension member and slideably coupled to the zip line. The stop bracket is configured to receive the carriage of the amusement ride.

According to another embodiment, an amusement ride includes a zip line and a passenger carriage that slideably coupled to the zip line. The amusement ride also includes first and second tubular elements spaced apart from each other. The zip line extends between the first and second tubular elements, where each of the first and second tubular elements defines an enclosed internal channel. Additionally, the amusement ride includes first and second pistons positioned within and movable along the internal channels of the first and second tubular elements, respectively. Further, the amusement ride includes a tension member that extends between the first and second tubular elements. The tension member is coupled to the first and second pistons. The amusement ride also includes a stop bracket that is coupled to the tension member between the first and second tubular elements. The stop bracket is slideably coupled to the zip line. Further, the stop bracket is configured to engage the passenger carriage of the amusement ride. Engagement between the stop bracket and the passenger carriage moves the first and second pistons along the internal channels of the first and second tubular elements, respectively.

In some implementations of the amusement ride, the internal channel contains a compressible substance. Additionally, the first piston sealingly divides the internal channel of the first tubular element into first and second sections. The second piston sealingly divides the internal channel of the second tubular element into first and second sections. Movement of the first and second pistons along the internal channels of the first and second tubular elements can compress the compressible substance in the first sections of the internal channels to dampen the motion of the passenger carriage. Movement of the first and second pistons along the internal channels of the first and second tubular elements may create a vacuum in the first sections of the internal channels to dampen the motion of the passenger carriage.

According to some implementations of the amusement ride, the tension member extends perpendicularly relative to the tubular elements and the zip line. The first and second tubular elements can extend parallel to each other in a substantially vertical orientation.

In some implementations of the amusement ride, the internal channel contains a compressible substance. Each of the first and second tubular elements can include a pressure release valve configured to release compressible substance from or receive compressible substance into the internal channels of the first and second tubular elements, respectively, as the first and second pistons move along the internal channels of the first and second tubular elements.

According to yet another embodiment, a method for dampening the motion of a passenger carriage along a zip line includes positioning a tension member in the path of a moving passenger carriage and engaging the moving passenger carriage with the tension member. The method can also include pulling a piston within an enclosed tubular element (the piston being coupled to the tension member) in response to the moving passenger carriage engaging the tension member. Additionally, the method includes compressing a compressible substance within the enclosed tubular element as the piston is pulled within the enclosed tubular element. Compression of the compressible substance dampens the motion of the piston and the moving passenger carriage.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a perspective view of a first example of a piston and cylinder mediated motion dampening system engaged with an amusement ride carriage according to one embodiment;

FIG. 2 is a perspective view of the piston and cylinder mediated motion dampening system of FIG. 1 before engaging the amusement ride carriage and with the platform removed according to one embodiment;

FIG. 3 is a perspective view of a tension member upper routing mechanism for the motion dampening system of FIG. 1;

FIG. 4 is a perspective view of a piston contained within the cylinder of the motion dampening system of FIG. 1; and

FIG. 5 is a perspective view of a tension member routed through the lower and upper routing mechanisms of FIGS. 2-3 and attached to the piston of FIG. 4.

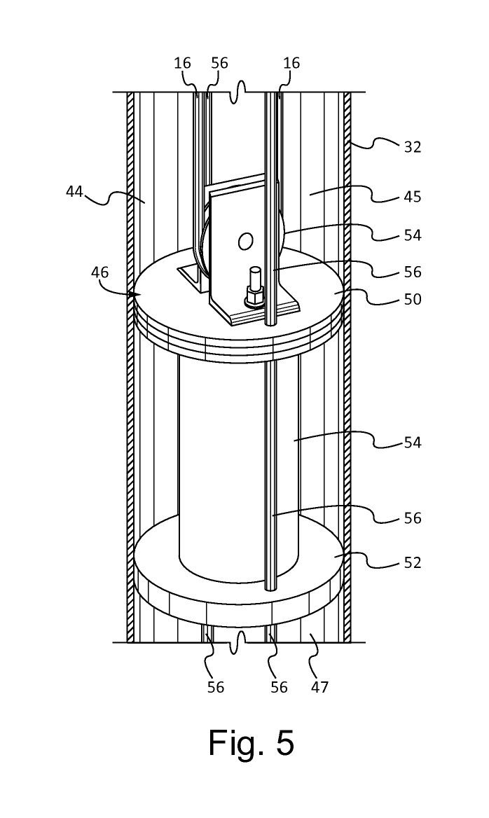

### DETAILED DESCRIPTION

Generally, one embodiment of the present disclosure relates to a system for slowing or stopping the motion of an amusement ride carriage. The system is a piston-mediated motion dampening system with a piston residing within a cylinder that is attached to a tension member. The tension member is routed out of the cylinder and into the path of a traveling carriage. Engagement between the carriage and the tension member causes the piston to be drawn upwards in the cylinder, which compresses a gas that resists movement of the piston. A second embodiment relates to a similar system, but relies on the compression of a fluid, rather than a gas.

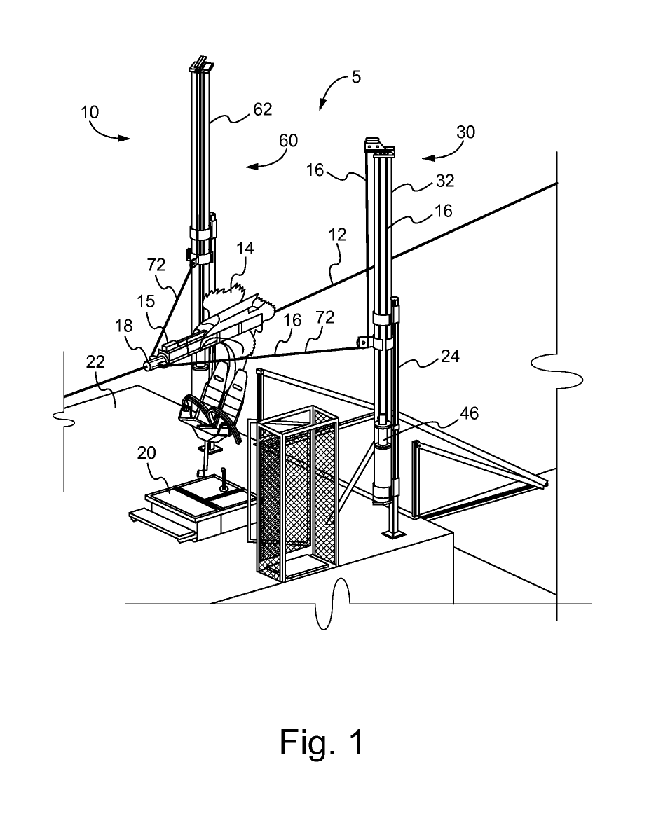

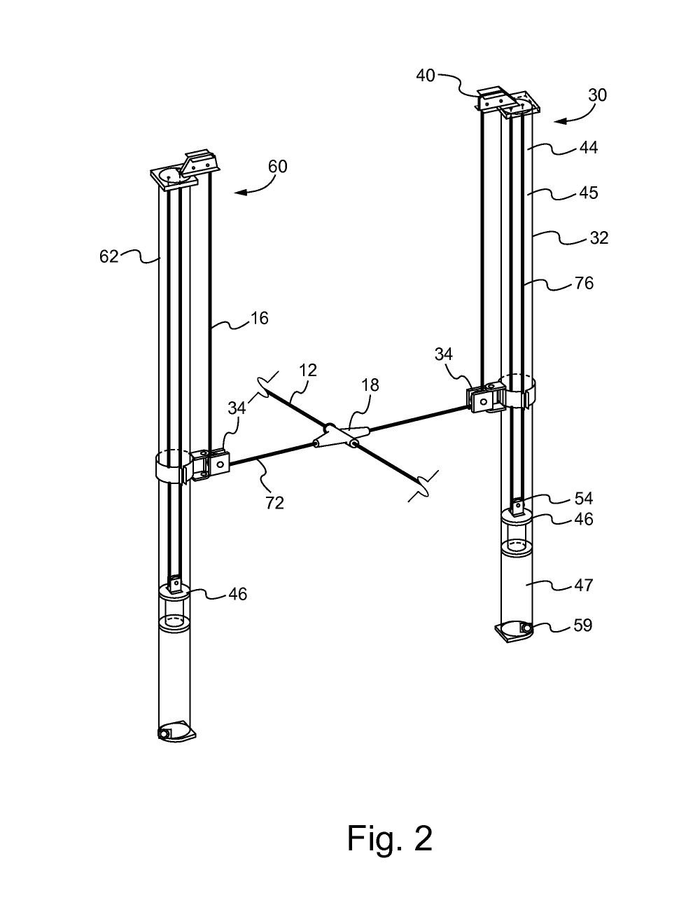

With reference to FIGS. 1 and 2, a motion dampening system 10 according to one embodiment is shown in conjunction with a zip-line type amusement ride 5 having an inclined zip line 12 and a carriage 14 that travels along the inclined zip line. Generally, the amusement ride 5 includes features for loading and unloading users from a carriage that travels along the inclined zip line 12, which can be a cable. Braking features of the motion dampening system 10 are configured to stop and position the carriage at (e.g., above) a stop location 20 of a platform 22 for user loading and unloading. The platform 22 can be raised relative to the ground, or the platform can be coextensive with the ground. The motion dampening system 10 includes a tension member 16, a first dampening mechanism 30, and a second dampening mechanism 60. Basically, the motion dampening system 10 functions to engage the moving carriage 14 at a carriage brake interface 15 on the forepart of carriage, and to correspondingly decelerate the moving carriage.

As can be seen in FIGS. 1 and 2, the tension member 16 is suspended between the first dampening mechanism 30 and the second dampening mechanism 60. In the instant example, the tension member 16 is a cable. In another example, the tension member is a synthetic band as is known in the art. In yet other examples, the tension member 16 is any elongate structure capable of interfacing with the carriage and transmitting forces from the moving carriage to the dampening mechanisms 30, 60 as the carriage decelerates to a stop. Preferably, in some embodiments, the tension member 16 is a substantially non-elastic, flexible cable. However, in other embodiments, the tension member 16 is an at least partially elastic, flexible cable. In certain implementations, the cable can be made from a metal or metal alloy, and include a plurality of intertwined metal bands.

The motion dampening system 10 includes a stop bracket 18 that slidably engages the zip line 12 and is freely slidable along the zip line. The stop bracket 18 also engages the tension member 16. For example, in one implementation, the tension member 16 extends through apertures in the stop bracket 18 to slidably engage the stop bracket with the tension member. Accordingly, the stop bracket 18 can be configured to movably couple the zip line 12 to the tension member 16 in one implementation. In other implementations, the stop bracket 18 may be non-movably secured to the tension member 16. Generally, the stop bracket 18 is configured to receive and contact the carriage 14. To this end, the stop bracket 18 may have a contact surface that engages a portion of the brake interface 15 of the carriage 14. Correspondingly, the brake interface 15 may have a contact surface that mates with the contact surface of the stop bracket 18. One or both of the contact surfaces may be substantially flat, and may have shock absorption elements (e.g., pads, cushions, etc.) to partially absorb the initial contact between the contact surfaces and reduce wear on the contact surfaces.

As shown in FIG. 2, when not in contact with the carriage 14, the stop bracket 18 is suspended on the zip line 12 at a location between the first and second dampening mechanisms 30, 60. In this non-engaged position, the tension member 16 extends substantially perpendicularly relative to the zip-line 12. Further, the first and second dampening mechanisms 30, 60 support a section 72 of the tension member 16 that extends between the dampening mechanisms perpendicularly relative to the dampening mechanisms. However, in other embodiments, the tension member 16 between the dampening mechanisms 30, 60 may be angled relative to the dampening mechanisms at some angle other than ninety-degrees if desirable.

As a moving carriage 14 slides along the zip line 12, in the direction indicated by the directional arrow, and contacts the suspended stop bracket 18, the forward momentum of the carriage “pushes” the stop bracket in the same direction (e.g., forward direction) along the zip line 12. Generally, as will be explained in more detail below, the first and second dampening mechanisms 30, 60 are configured to decelerate the carriage 14, or dampen the motion of the carriage and stop bracket, by applying an opposing force on the stop bracket in a backward direction to effectively “pull” on the stop bracket in the backward direction. The opposing force applied to the carriage 14 via the stop bracket 18 slows down, stops, and moves the carriage 14 backward to a position above the stop location 20

The first and second dampening mechanisms 30, 60 are spaced apart from each other such that the zip line 12 and stop location 20 are positioned between the dampening mechanisms. The second dampening mechanism 60 is substantially similar to the first dampening mechanism 30 in structure, composition, and function, and thus will not be redundantly explained. Although primary attention is given to the first dampening mechanism 30, it should be recognized that in the instant example, both mechanisms are working in a substantially contemporaneous manner.

The first dampening mechanism 30 includes an upright cylinder 32 which can be a generally hollow, enclosed, tube-like element. The upright cylinder 32 can be upright in a vertical orientation, angled orientation, or even in a horizontal orientation if desired. In one implementation, the upright cylinder 32 includes a hollow cylinder with capped or closed ends. The upright cylinder 32 can have a circular cross-sectional area in a preferred embodiment, or any of various non-circular cross-sectional areas, such as square, rectangular, triangular, ovular, etc., in other embodiments. Further, the upright cylinder 32 defines an internal channel 44 along which a piston 46 is movable as will be described in more detail below (see, e.g., FIG. 2). The upright cylinder 32 can be mounted directly to a support surface, such as the platform 22 shown in FIG. 1. Alternatively, in the illustrated embodiment, the motion dampening system 10 may include a support stand 24 that indirectly mounts the upright cylinder 32 to a support surface. In the instant example, the upright cylinder 32 is a standard rigid cylinder (e.g., metal cylinder) as known in the art. In a preferred embodiment, the upright cylinder 32 is made from a material capable of withstanding the forces exerted on it by the tension member 16. It should be recognized that in various embodiments the composition of the cylinder is selectable from a number of different materials, including steel, aluminum, alloys thereof, composites thereof, fiberglass, plastic, or other materials capable of performing consistent with the named materials.

The internal channel 44 of the upright cylinder 32 contains a volume of air corresponding to its height and circumference. The size of the upright cylinder 32, and the volume of air associated with the internal channel 44, is user definable and a function of a given set of amusement ride criteria. In one example, the upright cylinder 32 is 5 feet tall and has a circumference of 15 inches. In another example, the first dampening cylinder is 10 feet tall and has a circumference of 18 inches. A given user may select an appropriately sized upright cylinder 32 based upon a given application. Where more braking power is desired, a cylinder size is selected having a greater internal cylinder volume. Conversely, where less braking power is required a user may select a cylinder containing a smaller volume.

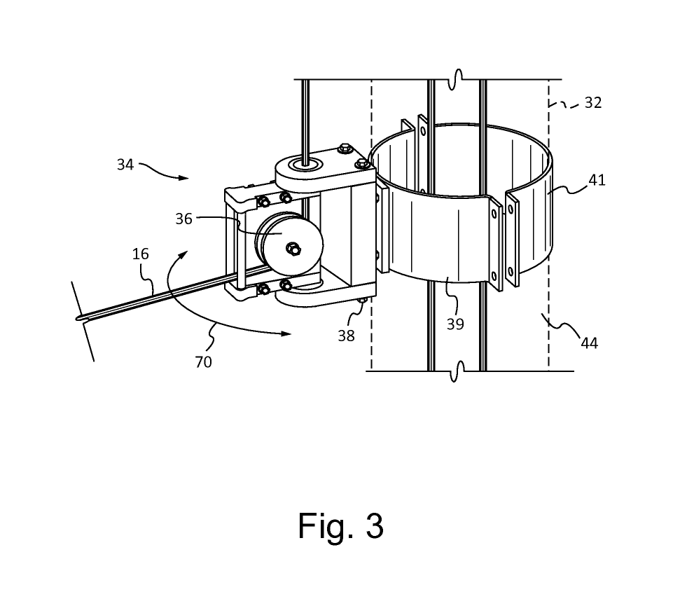

The first dampening mechanism 30 also includes a lower tension member routing mechanism 34, an upper tension member routing mechanism 40, an air baffle or check valve 58 (e.g., flow regulation device, which can be a pressure release valve), and the piston 46. Referring particularly to FIG. 2, the tension member 16 is shown passing through the lower routing mechanism 34 and up to the upper tension member routing mechanism 40. The lower routing mechanism 34 includes a lower pulley 36 that interfaces with the tension member 16 (see, e.g., FIG. 3). In the instant example, the lower pulley 36 can be a standard cable pulley as is known in the art. The lower pulley 36 can be complimentarily shaped to the width of the tension member 16. Generally, the lower pulley 36 allows the tension member 16 to nest against the lower pulley and be routed along the upright cylinder 32 towards the upper routing mechanism 40 as the lower pulley rotates.

In the instant embodiment, the lower routing mechanism 34 is fastened to the upright cylinder 32 via a mounting bracket 38. The mounting bracket 38 can include a pair of C-clamp sections 39, 41 clamped together about the upright cylinder 32. Alternatively, the lower routing mechanism 34 can be coupled to the upright cylinder 32 using any of various coupling techniques. The lower pulley 36 is coupled to the mounting bracket 38 in a swivelable manner such that the lower pulley 36 can swivel in the direction of the tension member 16 as it is acted upon by carriage 14 as shown by directional arrows 70. In other words, the lower pulley 36 can swivel about an axis that is parallel to the upright cylinder 26. A sidewall of the mounting bracket 38 is not displayed for convenience in showing details of the lower pulley 36.

The height of the section 72 of the tension member 16 relative to a reference point corresponds with the height of the lower routing mechanism 34 on the upright cylinder 32 relative to the same reference point. As discussed above, when the stop bracket 18 is not engaged with the carriage 14, the section 72 of tension member 16 between the upright cylinders extends substantially perpendicularly relative to the zip line 12. However, the position of the section 72 of the tension member 16 between the cylinders 30, 60 extends at an angle relative to the zip line 12 when the carriage 14 engages the stop bracket and draws the bracket forward in the direction of the travel of carriage 14. The swivel action made possible by mounting bracket 38 allows the section of the tension member 16 between the upright cylinders 32, 62 to follow the carriage 14 as it decelerates, while maintaining the orientation of the section 74 of the tension member 16 extending up to the upper routing mechanism 40 (e.g., parallel to the upright cylinder). It is noted that as the section 72 of tension member 16 between the upright cylinders follows the carriage 14, the length of this section increases proportionally relative to the position of the carriage. In some embodiments, the dampening mechanisms do not include a lower routing mechanism 34, such that the tension member extends from the top of the upright cylinders directly to the stop bracket.

Turning attention now to FIG. 3, a section 74 of the tension member 16 extending from the lower routing mechanism 34 is depicted being routed through the upper routing mechanism 40. The upper routing mechanism 40 is coupled to a top portion of the upright cylinder 32. Further, the upper routing mechanism 40 includes an upper pulley set 42 that include two horizontally spaced pulleys. In a manner similar to that described for the lower pulley 36, the pulleys of the upper pulley set 42 receives tension member 16 and directs the tension member downward into the channel of the upright cylinder 32 In the present embodiment, the upper routing mechanism 40 is fixed in a particular position relative to upright cylinder 32. In an alternative embodiment, the upper routing mechanism is configured to swivel relative to the upright cylinder 32.

In the instant example, and not by way of limitation, the upper pulley set 42 includes a pair of pulleys. In another example, a single pulley is sufficient, while in a different example, a third pulley is used. In each example, any number of pulleys capable of redirecting the tension member towards the piston 46 within the internal channel 44 of the upright cylinder 32 is sufficient.

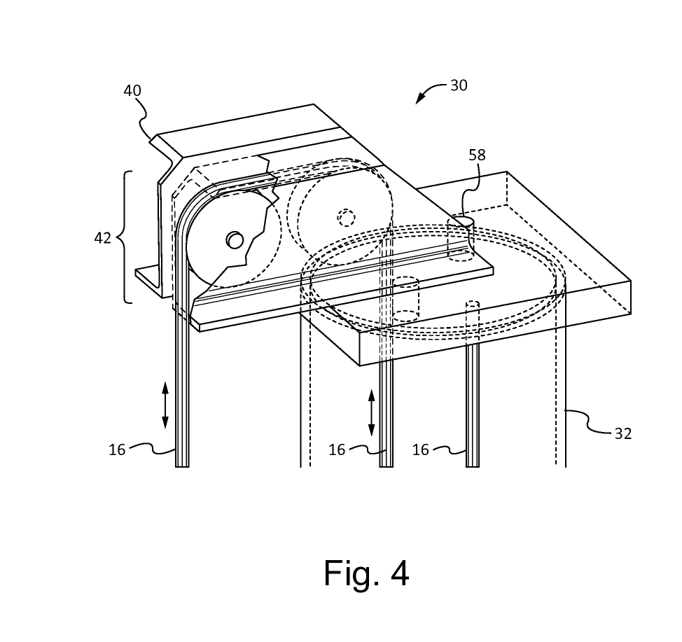

FIGS. 3 and 4 show the upper routing mechanism 40 redirecting the path of the tension member 16 into the internal channel 44 via the top of the upright cylinder to engage the piston 46. As shown in FIG. 4, the tension member 16 is tethered to the piston 46 via a pulley 48 mounted to the piston 46. The piston 46 moves along the internal channel 44 of the upright cylinder 32 as the length of a section 76 of the tension member 16 within the internal channel is reduced (e.g., when the carrier 14 pulls the tension member during deceleration to pull the piston 46 upward) and increased (e.g., as a vacuum is created in the internal channel below the piston to pull the piston 46 downward and bring the carrier forward). The mounted pulley 48 receives the tension member 16 in a manner similar to that described for the lower routing mechanism 34 and upper routing mechanism 40. FIGS. 3 and 4 depict tension member 16 routed around the pulley 48 and redirected upward to terminate proximate the upper routing mechanism 40 on the top of upright cylinder 32. In the instant example, an end of the tension member 16 is fixedly secured to the top of the upright cylinder 32 and the tension member 16 has a fixed overall length. In some embodiments, the dampening mechanisms do not include a pulley 48 attached to the pistons 46, such that respective ends of the tension member 16 are fixedly attached to the pistons.

Referring to FIG. 4, the piston 46 includes a top disk 50 fixedly coupled to a bottom disk 52 in a spaced-apart manner via a spacer 54. The top and bottom disks 50, 52 slidably (and in some cases sealingly) interface with the inner wall of the internal channel 44 of the upright cylinder. In the current example, as the piston 46 travels along the internal channel 44, the piston at least partially compresses the volume of air contained within the internal channel either above or below the piston depending on the direction the piston is moving. The compression of the air acts as a natural dampener of movement of the piston. In other words, the progressive compression of the air by the piston correspondingly progressively resists the movement of piston 46 through the upright cylinder 32. To facilitate linear travel of the piston 46 through the internal channel 44 and to prevent binding, the instant example additionally employs piston glides 56 to direct the piston along the channel. With reference to FIG. 4, the piston glides 56 include a pair of rigid metal rods extending between the top and bottom of the upright cylinder 32. The top and bottom disks 50, 52 of the piston include apertures through which the piston glides 56 extend. The engagement between the apertures in the disks, which are closely mated with the piston glides, and the piston glides helps to maintain the piston 46 in alignment with the internal channel and promotes smooth movement of the piston within the channel. In an alternative example, the piston glides 56 are cables similar to that of the tension member 16. In other examples, the piston glides 56 can be any structure capable of directing the piston along a path within the cylinder. In yet other examples, the motion dampening system does not utilize piston glides. The spacer 54 may include weights or be made from a relatively heavy or dense material such that, in some embodiments, the piston 46 has a weight greater than a maximum possible weight of the carriage 14 with passengers.

In another example, following essentially the same mechanical structure, the dampening cylinder is filled with a fluid, rather than a gas, creating a hydraulically dampened system. It should be recognized that both a pneumatic and a hydraulically dampened system could accomplish the motion dampening of the present disclosure. In one instance, a user may desire dampening characteristics achieved more suitably by a pneumatic system. In a second instance, a user may prefer the characteristics of a hydraulically dampened system over a pneumatic system.

It should be recognized that in alternative embodiments various routing means allow the tension member to be coupled with the piston within the upright cylinder. In a certain embodiment, the lower routing mechanism is permanently affixed to the dampening cylinder. In another embodiment the lower routing mechanism defines a tube through which the tension member may pass to be directed towards the piston. In yet other embodiments any structure capable of receiving the tension member from a first direction and rerouting the tension member to a second direction to interface with the piston is sufficient.

In operation, as the carriage 14 travels down the zip line 12 and contacts the stop bracket 18 of the tension member 16, forward-directed forces are exerted on the tension member 16, which ultimately cause the piston 29 to rise within the internal channel and dampen the forward motion of the carriage. More specifically, upon contact with the carriage 14, the stop bracket 18 and tension member 16 are driven from their resting position and become extended. As the section 72 of the tension member 16 between the upright cylinders 32, 62 extends, the remaining sections of the tension member are pulled through the lower routing mechanism 34, upper routing mechanism 40, and piston mounted pulley 48, which cause the piston 46 to rise within upright cylinder 32.

In the instant embodiment, the tension member 12 has a fixed length. Accordingly, the relative length of the section 72 of the tension member 16 between the upright cylinders 32, 62 is increased or decreased as a function of where the piston is within cylinder 32. As the piston 46 climbs towards the top of the cylinder, more tension member length is fed out of upright dampening cylinder 32 and the relative length of the section 72 of the tension member 16 is increased. Conversely, as piston 46 drops lower into cylinder 32, more tension member length is drawn into the cylinder and the relative length of the section 72 of the tension member 16 is decreased.

The dampening effect created within the upright cylinder 32 relies on a volume of gas being compressed within the cylinder 32 by the piston 46. As discussed above, as the piston begins to climb within cylinder 32, the volume of gas within the internal channel 44 in a first section 45 above piston 46 in the cylinder reaches a pressure sufficient to resist the motion of the piston. Accordingly, the pressure within the internal channel 44 above the piston 46 gradually increases to gradually push back on the piston in a downwardly direction to gradually slow down the piston, and thus the carriage 14. In some implementations, the initial increase in pressure within the internal channel 44 above the piston 46 does not immediately resist the upward movement of the piston 46. Accordingly, resistance of the upward movement of the cylinder and speed of the carriage is delayed until the pressure in the channel above the piston reaches some threshold dependent on the momentum of the carriage. In some embodiments, the baffle or check valve 58, which is formed in the upright cylinder above the piston (e.g., in a top cap of the upright cylinder), creates a restricted release of the pressurized cylinder gas. The release occurs after the carriage 14 is stopped in some embodiments. In other embodiments, the release occurs concurrently with compression of the air to effectuate a more controlled dampening of the carriage 14. In other words, the baffle 58 can be used to regulate the amount of compression of the air, and the rate of deceleration of the carriage. In this example, the baffle defines a hole located on and through a wall of cylinder 32 above the piston 46. Referring to FIG. 3, the baffle 58 is depicted at the top of cylinder 32 proximate upper routing mechanism 40. The size of the hole can be fixed to allow a fixed amount of air through the baffle during a compression stroke of the piston, or variable (e.g., via an actuatable valve) to vary the flow of air through the baffle during the compression stroke. As discussed above, in certain embodiments, the restriction of escaping gas allows a user to select the rate at which piston 46 moves through upright dampening cylinder 32 and thereby adjusts the rate at which carriage 14 is brought to a complete stop.

In alternative examples, the baffle is a tortuous-path baffle as is known in the art. In such examples, the escaping gas must travel through a channel through the cylinder wall, having multiple turns before it escapes into the environment external to the cylinder. In another example, the baffle is a pressure relief or check valve as is commonly known in the art. In various examples, any mechanism capable of regulating the rate at which a gas passes from inside the cylinder to the environment outside the cylinder is sufficient for use as a baffle.

Once the carriage 14 comes to a stop forward of the stop location 20, the baffle can be opened (or remain opened, or be opened wider) to allow the pressurized air within the upright cylinder above the piston 46 to escape, and allow the pressure within the cylinder above the piston to normalize with the atmospheric pressure.

It should be recognized that in various other embodiments, the dampening effect can be obtained, at least partially, by the regulation of air or gas flow into a second section 47 of the dampening cylinder below the piston rather than, or in addition to, out of the cylinder above the piston. In such examples, at least one baffle or check valve 59 (e.g., flow regulation device) is located on the cylinder below the resting height of the piston (see, e.g., FIG. 2). As the carriage engages the tension member, and the piston is pulled upwards through the gas volume, a vacuum pressure is generated below the piston. The vacuum pressure applies a downwardly directed force on the piston to effectively pull down on the piston as the piston moves upwardly. The downwardly directed force pulling down on the piston gradually slows the speed of the upwardly-traveling piston, which acts to correspondingly and gradually slow the speed of the carriage 14. As opposed to the delay of the pressurized air above the piston 46 at slowing down the carriage 14 (e.g., due to the require buildup of pressure), the vacuum pressure below the piston has an immediate impact on slowing down the carriage. Accordingly, the vacuum pressure below the piston starts reducing the speed of the carriage before the pressurized air above the piston.

In some implementations, to release the negative pressure below the piston and allow the piston to travel downwardly along the internal channel 44 (e.g., after the carriage has stopped), the lower baffle or check valve 59 can be opened to allow air outside the channel to flow into the channel. Further, to control the negative pressure or vacuum effect in the internal channel 44 below the piston, the check valve 59 can be used to draw in air external to the cylinder at a user-selected rate while the piston is traveling upwardly and the carriage is slowing down. The more restriction on the baffle, the slower the piston would travel in the cylinder (e.g., the more resistance on the motion of the piston (and carriage) or the greater the motion-dampening of the piston (and carriage)), and vice versa. In certain examples, a combination of multiple baffles is used above and below the resting height of the piston. The combination of baffles is cooperatively controlled to create a precisely controlled, highly responsive, user-selected motion dampening effect. Alternatively, the lower baffle can remain closed during the piston compression stroke, such that the vacuum effect below the piston 46 is intensified. The vacuum created below the piston can be used to assist in the dampening of the carriage 14 as discussed above.

Additionally, the vacuum effect can be used to draw the piston 46 down and move the carriage backward over the stop location 20 after the carriage has stopped. Alternatively, or additionally, the weight of the piston 46 is sufficient that the piston simply drops back to its resting height automatically after the carriage 14 stops, which moves the carriage backward into the loading/unloading position. In some embodiments, the bottom baffle is opened once the top baffle is opened. In this manner, the pressurized air above the piston is normalized at the same time that the low pressure air below the piston is normalized. The weight of the piston 46 may then facilitate a gradual return of the carriage to the loading/unloading position and the section 72 of the tension member 16 back to substantially perpendicular relative to the zip line 12.

Without deviating from the essence of the current disclosure, some dampening regulation in particular embodiments is achieved by adding a baffle to the body of the piston itself. FIG. 4 for example, includes piston disk 50 and a piston disk 52. These sections interface the interior wall of the upright cylinder 32 and do not allow a significant amount of air to pass between the cylinder wall and the piston. This relatively air-tight junction causes efficient pressurizing of the gas volume above the cylinder. The piston mounted baffle can add yet more adjustability to the dampening system. Additionally such an embodiment assists in eliminating any unwanted vacuum-pressure locking of the piston within the cylinder.

In the examples discussed above employing a hydraulic fluid rather than a gas, a baffle further consists of a fluid reservoir capable of collecting and draining hydraulic fluid that is passed out of the cylinder.

Although the illustrated embodiments have been described in relation to a zip-line type amusement ride, the motion dampening system of the present disclosure may be used with any of various types of amusement rides to dampen the motion of any of various objects and people without departing from the essence of the subject matter. Further, the motion dampening system of the present disclosure may be used in non-amusement applications to dampening the motion of any of various objects in any of various applications.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A motion dampening system for dampening the motion of a moving object, comprising:
a tension member comprising a first portion and a second portion, the first portion being positionable to contact the moving object;
a tubular element configured to receive the second portion of the tension member, the tubular element containing a compressible substance; and
a piston movable within the tubular element, the piston being coupled to the second portion of the tension member and sealingly dividing the tubular element into first and second sections, wherein contact between the moving object and the first portion of the tension member moves the piston within the tubular element to compress the compressible substance in the first section and to create a vacuum in the second section.

2. The motion dampening system of claim 1, further comprising a flow regulation device that is operable to control the flow of the compressible substance from the first section.

3. The motion dampening system of claim 2, wherein the flow regulation device is operable to allow a portion of the compressible substance to flow from the first section as the piston moves within the cylinder to compress the compressible substance in the first section.

4. The motion dampening system of claim 1, further comprising a flow regulation device that is operable to control the flow of the compressible substance into the second section.

5. The motion dampening system of claim 4, wherein the flow regulation device is operable to allow a compressible substance to flow into the second section as the piston moves within the cylinder to compress the compressible substance in the first section.

6. The motion dampening system of claim 1, further comprising a first flow regulation device that is operable to control the flow of the compressible substance from the first section and a second flow regulation device that is operable to control the flow of the compressible substance into the second section, wherein the first and second flow regulation devices are cooperatively operable to allow a portion of the compressible substance to flow from the first section and allow a compressible substance to flow into the second section as the piston moves within the cylinder to compress the compressible substance in the first section.

7. The motion dampening system of claim 1, wherein the tubular element is elongate in a first direction, the first portion of the tension member extends perpendicularly relative to the first direction, and the second portion of the tension member extends parallel to the first direction.

8. The motion dampening system of claim 1, further comprising a pulley coupled to the tubular element, the pulley being engaged with the first portion of the tension member, and wherein the pulley is swivelable relative to the tubular element to allow the first portion of the tension member to pivot about the pulley.

9. The motion dampening system of claim 1, wherein the piston comprises a first disk, a second disk, and a spacer extending between the first and second disks, and wherein the first and second disks move along and form a seal against an interior surface of the tubular element.

10. The motion dampening system of claim 1, wherein the piston comprises a flow regulation device that is operable to control the flow from the first section to the second section as the piston moves within the cylinder to compress the compressible substance in the first section.

11. The motion dampening system of claim 1, wherein the moving object is a carriage of an amusement ride that slides along a zip line extending perpendicularly relative to the first portion of the tension member.

12. The motion dampening system of claim 11, further comprising a stop bracket coupled to the first portion of the tension member and slideably coupled to the zip line, wherein the stop bracket is configured to receive the carriage of the amusement ride.

13. An amusement ride, comprising:
a zip line;
a passenger carriage slideably coupled to the zip line;
first and second tubular elements spaced apart from each other, the zip line extending between the first and second tubular elements, wherein each of the first and second tubular elements defines an enclosed internal channel;
first and second pistons positioned within and movable along the internal channels of the first and second tubular elements, respectively;
a tension member extending between the first and second tubular elements, wherein the tension member is coupled to the first and second pistons; and
a stop bracket coupled to the tension member between the first and second tubular elements, and slideably coupled to the zip line, the stop bracket being configured to engage the passenger carriage of the amusement ride, wherein engagement between the stop bracket and the passenger carriage moves the first and second pistons along the internal channels of the first and second tubular elements, respectively.

14. The amusement ride of claim 13, wherein the internal channel contains a compressible substance, and wherein the first piston sealingly divides the internal channel of the first tubular element into first and second sections, and the second piston sealingly divides the internal channel of the second tubular element into first and second sections.

15. The amusement ride of claim 14, wherein movement of the first and second pistons along the internal channels of the first and second tubular elements compresses the compressible substance in the first sections of the internal channels to dampen motion of the passenger carriage.

16. The amusement ride of claim 14, wherein movement of the first and second pistons along the internal channels of the first and second tubular elements creates a vacuum in the first sections of the internal channels to dampen motion of the passenger carriage.

17. The amusement ride of claim 13, wherein the tension member extends perpendicularly relative to the tubular elements and the zip line.

18. The amusement ride of claim 13, wherein the first and second tubular elements extend parallel to each other in a substantially vertical orientation.

19. The amusement ride of claim 13, wherein the internal channel contains a compressible substance, and wherein each of the first and second tubular elements comprises a pressure release valve configured to release compressible substance from or receive compressible substance into the internal channels of the first and second tubular elements, respectively, as the first and second pistons move along the internal channels of the first and second tubular elements.

20. A method for dampening motion of a passenger carriage along a zip line, the method comprising:
positioning a tension member in a path of a moving passenger carriage;
engaging the moving passenger carriage with the tension member;
pulling a piston within an enclosed tubular element and coupled to the tension member in response to the moving passenger carriage engaging the tension member; and
compressing a compressible substance within the enclosed tubular element as the piston is pulled within the enclosed tubular element, wherein compression of the compressible substance dampens motion of the piston and the moving passenger carriage.
